(19) United States
(12) Patent Application Publication
(10) Pub. No.: US 2008/0211944 A1
(43) Pub. Date: Sep. 4, 2008

(54) Imaging device, image recording/playback apparatus, and power supply control method for imaging device

(75) Inventor: Kiyoshi Yamauchi, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 11/985,237

(22) Filed: Nov. 14, 2007

(30) Foreign Application Priority Data
Dec. 8, 2006 (JP) P2006-331611

(51) Int. Cl. H04N 3/14

(52) U.S. Cl. 348/294; 348/E03.016

(57) ABSTRACT

An imaging device with a solid-states image sensor includes a recording/playback section that records a captured image signal on a recording medium and reads the recorded signal, a recording/playback control section that controls recording and playback operations of the recording/playback section, a monitor image processing section that generates a display image signal for monitor displaying on the basis of the captured image signal, a power supply section having power supply circuits for at least the above three sections, and a system control section that controls a power supply condition by selecting one of operation modes including a power save mode in which power is not supplied to the recording/playback section and the recording/playback control section performs minimum processing necessary for a recovery operation of the recording/playback section, while power is supplied to the monitor image processing section to generate the display image signal.

### CROSS REFERENCES TO RELATED APPLICATIONS

The present invention contains subject matter related to Japanese Patent Application JP 2006-331611 filed in the Japanese Patent Office on Dec. 8, 2006, the entire contents of which are incorporated herein by reference.

### BACKGROUND OF THE INVENTION

1. Field of the Invention

The present invention relates to an imaging device, an image recording/playback apparatus, and a power supply control method for the imaging device. More particularly, the present invention relates to an imaging device, an image recording/playback apparatus, and a power supply control method for the imaging device, capable of reducing power consumption and suitable for battery drive.

2. Description of the Related Art

A video cameras in which an image-capturing unit and a recording/playback unit are integrally provided are being popular. To shoot an image with such a video camera, the video camera is once brought into a standby state to activate circuits, and then a start button is pressed to allow a video signal recording section to start running of a video tape. Since the operation of the start button does not directly cause the activation of the circuits, and the shooting is started after the video camera is once brought into the standby state, the shooting can be started immediately after the start button is operated, thereby shooting an image in a proper timing.

However, the power consumption in the standby state is substantially equivalent to that during shooting. Owing to this, as the period of the standby state extends, the duration of a battery for actual shooting becomes short. Hence, for example, Japanese Unexamined Patent Application Publication No. 03-191685 (see pages 3 to 4, and FIG. 2) discloses a power save method using a standby off mode in which a power supply of a video signal processing circuit is turned off even when a camera is in a standby state, so as to reduce power consumption in the standby state.

In addition, Japanese Unexamined Patent Application Publication No. 06-292062 (see paragraph [0017], and FIG. 3) discloses another power save method for a video camera provided with an optical view finder. With this method, in a recording standby state, power is supplied to a circuit used to immediately start recording in response to the input of a recording-start instruction, but power is not supplied to a circuit provided in a camera unit for generating a video signal, thereby reducing the power consumption. Also, in the recording standby state, power is not supplied to a signal processing circuit that generates a recording signal in a vide tape recorder (VTR) unit.

### SUMMARY OF THE INVENTION

In a case of a professional-use video camera, for example, when shooting does not have to be started immediately such as for making a TV program in a studio, a standby mode may be selected, and a not-recording condition may be continued for a long time while a monitor image is continuously output, unlike a situation of electronic news gathering (ENG) shooting for gathering information for news. In this case, the power is desired to be saved more sufficiently than the saved amount of power consumption achieved by the standby off mode used in the video camera of the related art.

Accordingly, it is desirable to provide an imaging device, an image recording/playback apparatus, and a power supply control method for the imaging device, capable of further reducing power consumption.

An imaging device according to an embodiment of the present invention captures an image using a solid-state image sensor. The device includes a recording/playback section that records a captured image signal as a recording signal on a recording medium and reads the recorded signal as a playback signal, a recording/playback control section that controls a recording operation and a playback operation performed in the recording/playback section, a monitor image processing section that generates a display image signal for monitor displaying on the basis of the captured image signal, a power supply section having a plurality of power supply circuits for supplying power independently to at least the recording/playback section, the recording/playback control section, and the monitor image processing section, and a system control section that controls a condition of power supply from the power supply section by selecting one of a plurality of operation modes including a power save mode in which the power supply circuit for supplying power to the recording/playback section is stopped and the recording/playback control section is driven to perform minimum processing necessary for a recovery operation of the recording/playback section, while power is supplied from the power supply section to the monitor image processing section to generate the display image signal.

With such a device, the plurality of power supply circuits are provided in the power supply section, for supplying power independently to at least the recording/playback section, the recording/playback control section, and the monitor image processing section, and the system control section shifts the condition of power supply from the power supply section in accordance with the plurality of operation modes. The operation modes include the power save mode in which the power supply circuit for supplying power to the recording/playback section is stopped and the recording/playback control section is driven to perform minimum processing necessary for a recovery operation of the recording/playback section, while power is supplied from the power supply section to the monitor image processing section to generate the display image signal. In the power save mode, power is not supplied to the recording/playback section, and the recording/playback control section capable of allowing the recording/playback section to be returned to the normal operation is driven in the sleep mode while allowing the captured image to be monitored. Accordingly, although a certain period of time is necessary to start the recording operation, the power consumption can be markedly reduced. For example, the power consumption can be particularly markedly reduced when the standby state for the request of recording is continued for a long time.

### BRIEF DESCRIPTION OF THE DRAWINGS

FIG. 1 is a block diagram showing a primary configuration of a camcorder according to an embodiment;

FIG. 2 is a table showing power supply conditions in various operation modes of the camcorder;

FIG. 3 is an illustration showing a circuit block related to a power save mode (first mode);

FIG. 4 is an illustration showing circuit blocks related to a power save mode (second modes); and

FIG. 5 is an illustration showing transition of modes to explain usage patterns of the camcorder.

### DESCRIPTION OF THE PREFERRED EMBODIMENTS

Embodiments of the present invention are described below with reference to the drawings. Herein, it is assumed that an exemplary configuration of a recording/playback apparatus integrated with a camera has a recording unit which uses a magnetic tape.

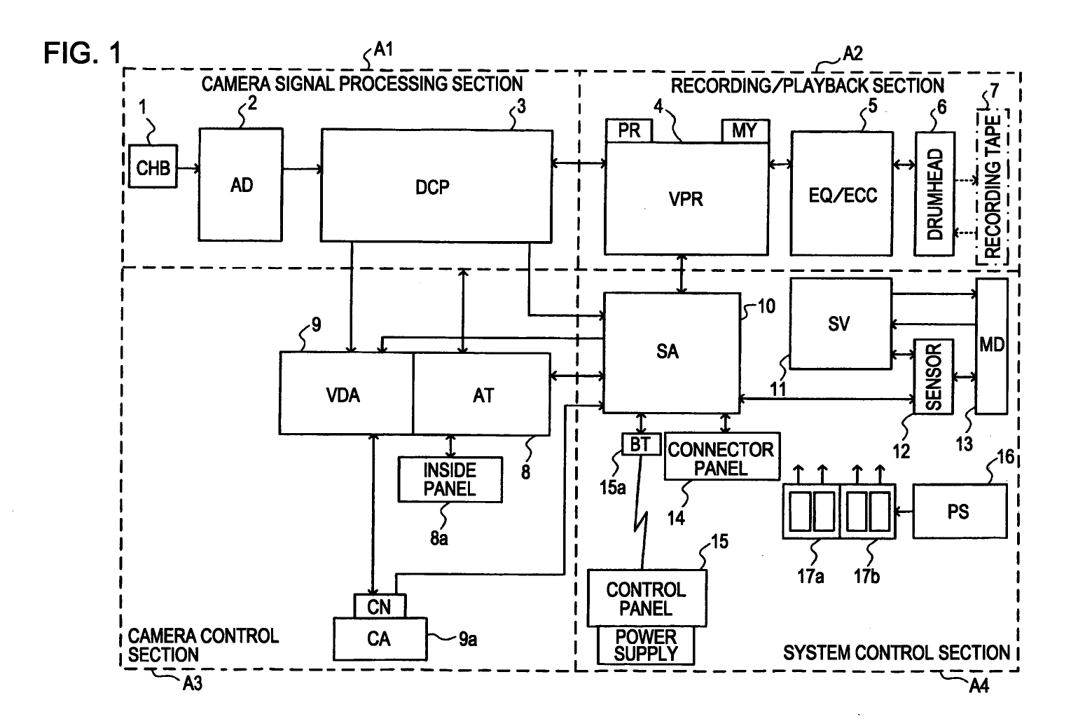

FIG. 1 is a block diagram showing a primary configuration of a camcorder according to an embodiment.

In a camcorder in which a camera is integrated with a VTR, a camera head block (CHB) 1, an A/D converter circuit (AD) 2, and a digital camera processor (DCP) 3 constitute a camera signal processing section A1, and a video processor (VPR) 4, an equalizer/error correcting code (ECC) circuit (EQ/ECC) 5, and a drumhead 6 constitute a recording/playback section A2 for a recording tape 7.

The camera head block (CHB) 1 of the camera signal processing section A1 has charge coupled devices (CCDs) and optical system components. The CHB 1 converts a focused image into an electric video signal and outputs the signal to the A/D converter circuit (AD) 2.

The digital camera processor (DCP) 3 applies correction and compensation to the video signal so that the signal becomes a digital video signal of a predetermined format such as a YC (luminance/color difference) signal of 4:2:2 mode. When a 10-bit or 12-bit digital video signal (low voltage differential signaling, LVDS) is input from the A/D converter circuit (AD) 2, the DCP 3 serially converts the received signal, and outputs the converted signal in frame (S-LVDS) to the video processor (VPR) 4 of the recording/playback section A2.

The video processor (VPR) 4 of the recording/playback section A2 uses memories PR and MY to perform encoding and decoding, including image motion compensation, on the basis of the moving picture experts group (MPEG) standard, or the like.

The equalizer/ECC circuit (EQ/ECC) 5 includes a filter circuit for characteristics compensation by adaptively equalizing a recording/playback signal, an error correcting processing circuit, a control circuit for controlling rotation of the drumhead 6, and the like.

A camera control section A3 controls the camera signal processing section A1, and includes a camera controller (AT) 8, and a video D/A converter (VDA) 9. The camera controller (AT) 8 controls lens focusing and zooming in the camera head block (CHB) 1, and controls image quality, exposure, and white balance in the digital camera processor (DCP) 3. The camera controller (AT) 8 also serves as a main controller for controlling the entire camcorder. Through described below, the AT 8 includes a mode control function for reducing power consumption of the entire camcorder. The camera controller (AT) 8 is connected to various terminal units via an inside panel 8a.

The video D/A converter (VDA) 9 receives an image signal processed by the digital camera processor (DCP) 3 and outputs a video signal for displaying a monitor image on a view finder or the like. The video D/A converter (VDA) 9 is connected to a camera adapter (CA) 9a for audio input etc., via a connector CN configured to connect external devices. An analogue audio signal input from the camera adapter (CA) 9acan be also supplied to a system/audio controller (SA) 10.

A system control section A4 of the VTR side includes the system/audio controller (SA) 10, a servo controller (SV) 11, a sensor circuit 12, a mechanical deck (MD) 13, a connector panel 14, a control panel 15 which is remote-controlled using a Bluetooth terminal 15a, a main power supply (PS) 16, and the like.

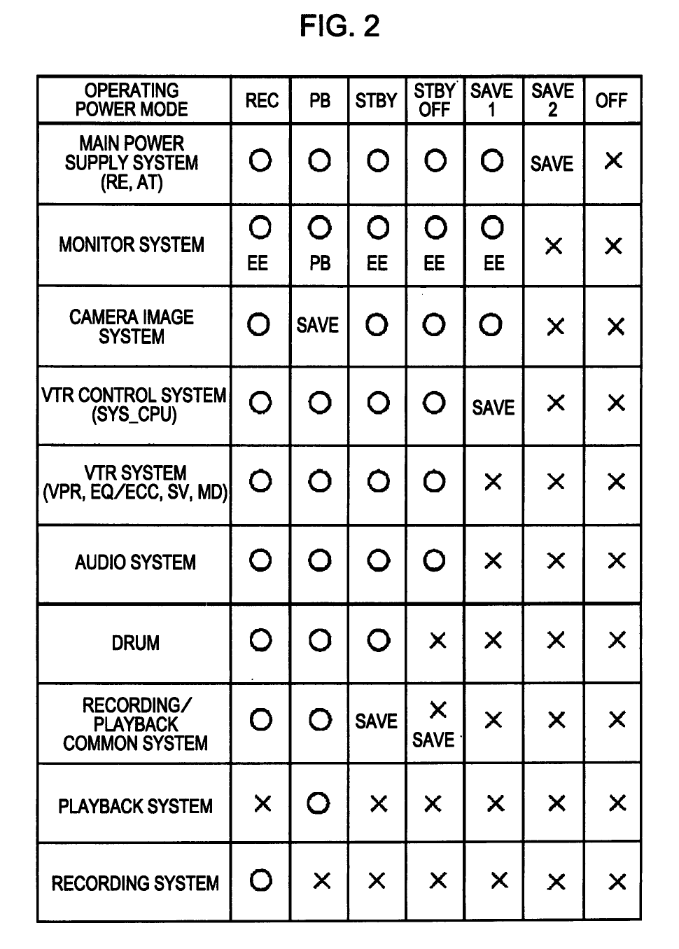

The main power supply (PS) 16 has a power switch (not shown), and is connected to regulators 17a and 17b, each of which has a plurality of DC/DC converters. The on-off control of power supply to the sections A1 to A4 is performed in accordance with operation modes shown in FIG. 2 (described below).

The system/audio controller (SA) 10 receives signals from various switches via the connector panel 14, and controls the video processor (VPR) 4. Also, the SA 10 controls the camera side using the camera controller (AT) 8. The servo controller (SV) 11 has a plurality of motor drivers to control running of the recording tape 7 driven by the mechanical deck (MD) 13.

Operating power modes applied to the main power supply (PS) 16 of the camcorder are described.

FIG. 2 is a table showing power supply conditions in various operation modes of the camcorder.

Now, a recording mode, a playback mode, a standby mode, and a standby off mode are described. In the table, the cross sign represents a circuit block without power supplied, and the circle sign represents a circuit block with power supplied. The term “OFF” indicated in the right end in FIG. 2 represents a power off state. The circuits of the camcorder are divided into a main power supply system block, a monitor system block, a camera image system block, a VTR control system block, a VTR system block, an audio system block, a drum block, a recording/playback common system block, a playback system block, and a recording system block.

### [Recording Mode: REC]

The recording mode is an operation mode for recording in the camcorder. In the recording mode, a captured image signal and an audio signal are recorded on a magnetic tape, and a monitor image (camera electric to electric (EE) image) is displayed on the view finer or the like. In the recording mode, power is not supplied to a playback system circuit block, in particular, an image decode circuit and an audio signal playback circuit of the video processor (VPR) 4, and a playback image output circuit and the like of the equalizer/ECC circuit (EQ/ECC) 5.

### [Playback Mode: PB]

The playback mode is an operation mode for playback of an image and sound recorded on the recording tape 7. In the playback mode, power is not supplied to the recording system circuit block, in particular, an image encode circuit and an audio signal input circuit of the video processor (VPR) 4, and a recording image input circuit of the equalizer/ECC circuit (EQ/ECC) 5. The power supply condition to a monitor image (camera EE image) system from the camera head block (CHB) 1 is brought into a save state, and the power is normally supplied only to a playback image (PB) system from the recording/playback section A2. Also, power is not supplied from the servo controller (SV) 11 to circuits for instructing operations of fast forward (FF), rewind (REW), and temporary stop (PAUSE) given to the mechanical deck (MD) 13.

### [Standby Mode: STBY]

The standby mode is an operation mode for preparing the recording and playback operations. This operation mode is selected such as when a stop button or the like provided at the control panel 15 is operated during recording or playback. In the standby mode, power is not supplied to the circuit blocks used in the recording and playback modes.

However, power is still supplied to a central processing unit (CPU) in the system/audio controller (SA) 10 that controls the video processor (VPR) 4 and the equalizer/ECC circuit (EQ/ECC) 5, and drum rotation by the drumhead 6 is continued. That is, power is supplied to circuits with start time longer than the pre-running time of the recording tape 7 when the next recording operation or the next playback operation is started. For example, in the servo controller (SV) 11, a CPU used for servo control is being activated, however, power is not supplied to sensors used for servo control because the sensors may be quickly activated as compared with the CPU.

With this mode, the circuits commonly used for the recording and playback operations are brought into a save state, and power is supplied to a monitor image (camera EE image) system. Accordingly, the recording operation or the playback operation can be selected smoothly while power being saved.

### [Standby Off Mode: STBYOFF]

The standby off mode is an operation mode that allows the power consumption to be further reduced. In this mode, power is not supplied to the drumhead 6, and circuits necessary for the activation are driven in the servo controller (SV) 11 (for example, the CPU used for the servo control is driven in a power save mode). Also, the video processor (VPR) 4 of the recording/playback common system block is brought into a power save mode, and communication with, for example, the system/audio controller (SA) 10 is allowed, thereby providing ease of the activation.

Therefore, in the recording/playback section A2 and the system control section A4 of the VTR side, circuits with start time longer than a period of time necessary for servo lock when the rotation of the drumhead 6 is started and for the pre-running time of the recording tape 7. At this time, a monitor image (camera EE image) is displayed on the view finer or the like, and the recording or playback operation can be performed when a certain period of time has elapsed after operation of a predetermined button of the control panel 15.

The above-described four operation modes are similar to those of a power save method of the related art. Next, in addition to the above-described standby off mode, newly provided, two power save modes (SAVE1, SAVE2) are described.

### [VTR Off Mode: SAVE1]

A VTR off mode is an operation mode for supplying power only to minimum circuit blocks of the camera side to display a monitor image (camera EE image). In this mode, the DC/DC converters corresponding to the regulator 17b are stopped, and hence, power is not supplied to the recording/playback section A2 of the VTR side. Also, in the system control section A4, power is not supplied to circuit blocks related to audio data. At this time, the system/audio controller (SA) 10 is brought into a power save mode, and only the CPU thereof is driven in a sleep mode, so as to perform a task necessary for the recovery operation. Thus, the VTR off mode uses a period of time to start the recording or playback operation using the camcorder as compared with the case of the standby off mode, however, this mode can provide a condition with the power consumption further reduced.

### [Shutdown Mode: SAVE2]

In a shutdown mode, only the CPU (namely, main controller) of the camera controller (AT) 8 is driven in a sleep mode, and no monitor image (camera EE image) is displayed. The main power supply (PS) 16 and a predetermined DC/DC converter in the regulator 17a for supplying power from the PS 16 to the camera controller (AT) 8 are operated, and hence, residual circuit blocks are brought into a power save condition (second power save mode) in which all other operations of the residual circuit blocks are stopped. In the power save condition, operations of limited keys provided at the inside panel 8a are allowed.

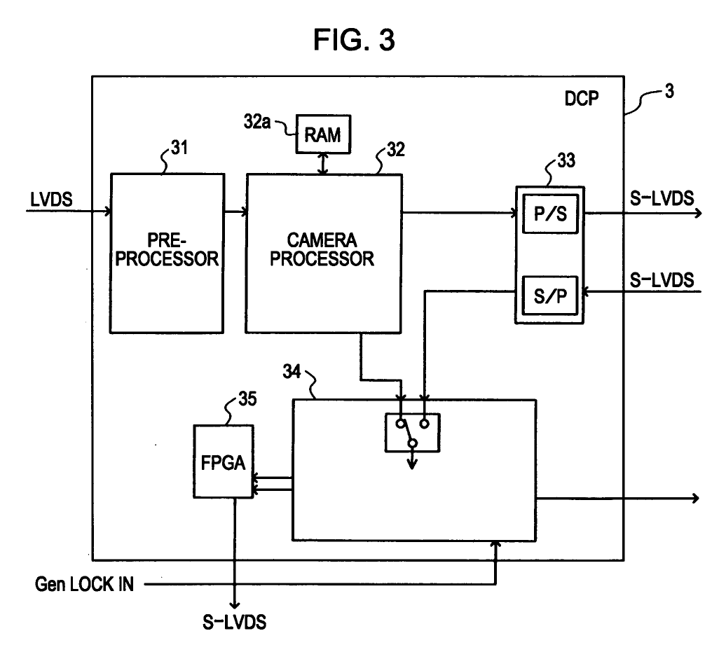

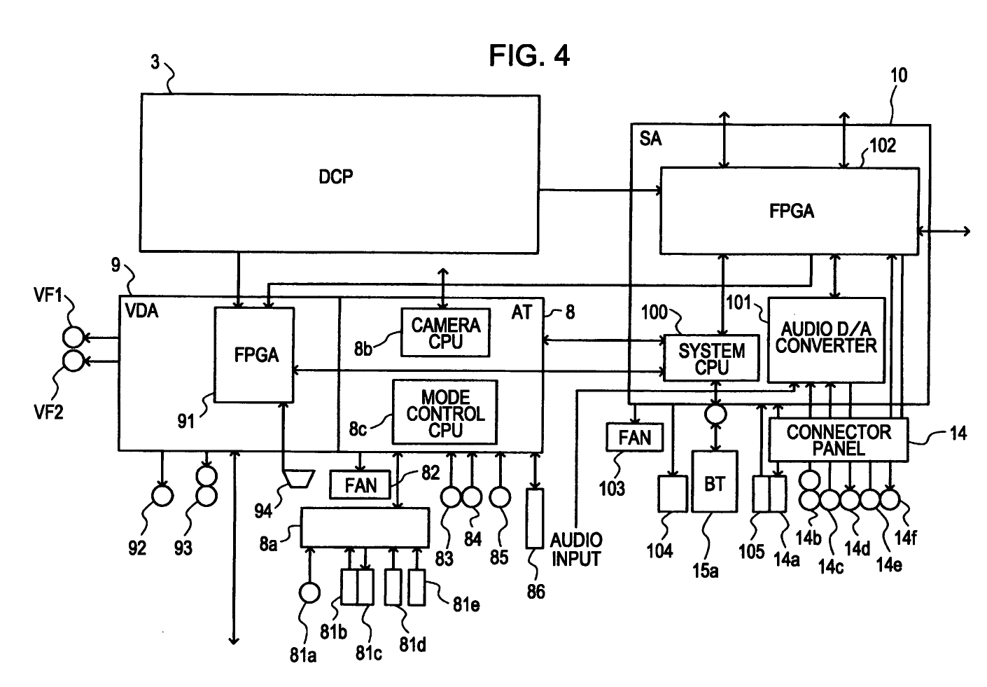

FIGS. 3 and 4 are illustrations showing circuit blocks related to the power save modes.

As shown in FIG. 3, the digital camera processor (DCP) 3 includes a pre-processor 31, a camera processor 32, signal processing circuits 33 to 35, and the like.

The pre-processor 31 is a signal processing circuit for receiving a digital video signal. The camera processor 32 applies non-linear processing such as gamma correction, and camera processing such as edge enhancement and color correction, to the video signal input from the A/D converter circuit (AD) 2, and converts the image signal into a signal of a predetermined color-space format (for example, YC signal of 4:2:2 mode). In this case, for example, assume that a YC (luminance/color difference) signal of 4:2:2 mode and an RGB signal of 4:4:4 mode can be output.

The signal processing circuit 33 converts a recording video signal into serial data and outputs the data, and converts a playback video signal into parallel data. The signal processing circuit 34 selects one of a playback image and a camera image, and generates additional information like a character. The signal processing circuit 35 converts the playback video signal into a signal that is output to the camera control section A3.

In FIG. 4, the detailed configurations of the camera controller (AT) 8, video D/A converter (VDA) 9 and system/audio controller (SA) 10 are shown.

The camera controller (AT) 8 includes a camera CPU 8b for mainly controlling the camera signal processing section A1, and a mode control CPU 8c serving as a main controller for controlling the above-described operation modes with different power-supply conditions. The video D/A converter (VDA) 9 includes a field programmable gate array (FPGA) circuit 91 for signal processing so as to convert video and audio signals and output the signals.

The camera controller (AT) 8 is connected to a cooling fan 82, a lens signal input terminal 83, a remote signal terminal 84, a meta input/output terminal 85, and a memory slot 86, as well as to a menu enter terminal 81a, a menu switch 81b, a liquid crystal display (LCD) terminal 81c, a main power switch 81d, and a VTR start/stop button 81e, via the inside panel 8a. Control signals etc. provided among these terminals and devices are controlled by the camera CPU 8b or the mode control CPU 8c.

The video D/A converter (VDA) 9 includes two signal output terminals VF1 and VF2 directed to the view finder, an output terminal 92 of a video synchronization (Y/SYNC/VBS) signal, a terminal 93 for extracting a high definition-serial digital interface (HD-SDI) signal and outputting the signal to a monitor, an RS232C terminal 94, and the like.

The system/audio controller (SA) 10 includes a system CPU 100 for controlling the entire VTR system, an audio D/A converter 101 for conversion between digital audio data and analogue audio data, an FPGA circuit 102 for signal processing to generate a time code and a timing signal for editing an image, and the like. Also, the system/audio controller (SA) 10 is connected to a cooling fan 103, a display light emitting diode (LED) 104, and a cassette eject button 105, as well as to a universal serial bus (USB) terminal 14a, an audio input terminal 14b, a sound volume 14c, an audio output terminal 14d, and time code (TC) input/output terminals 14e and 14f, via the connector panel 14.

The system CPU 100 receives and transmits a control signal such as Cam-VTR protocol from and to the camera controller (AT) 8, and receives and transmits a sound output control signal from and to the signal processing circuit 91 of the video D/A converter (VDA) 9.

In the VTR off mode (SAVE1) which is the above-described first power save mode, power is supplied only to the circuit blocks for outputting the image from the digital camera processor (DCP) 3 to the view finder via the signal output terminals VF1 and VF2, and minimum power is supplied to the system/audio controller (SA) 10 so as to drive only the system CPU 100 in the sleep mode. To supply power only to designated portions of the circuit-block sections A1 to A4 via the regulators 17a and 17b from the main power supply (PS) 16, the condition between the power supply and the electrically disconnected circuit is brought into a high impedance state so as to prevent current from flowing to the electrically disconnected circuit.

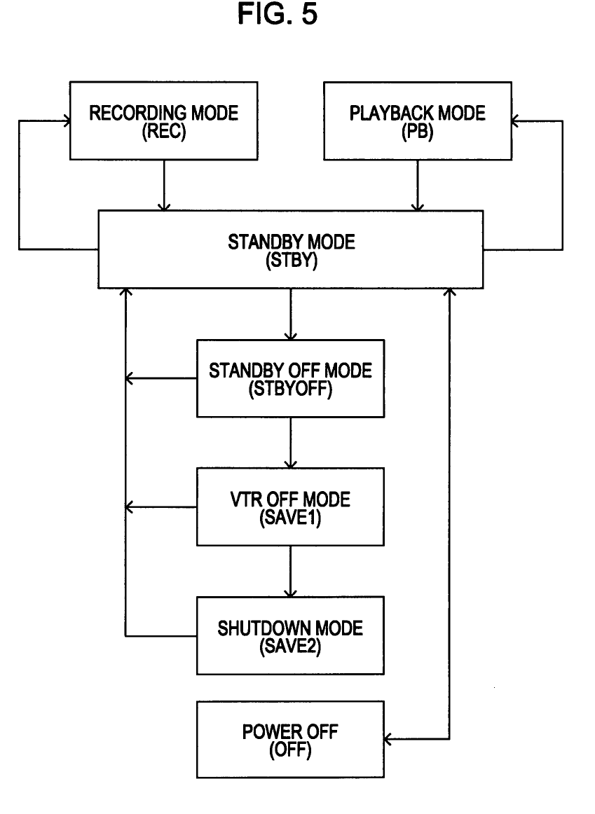

FIG. 5 is an illustration showing transition of modes to explain usage patterns of the camcorder. The following control of the operation modes is performed by the mode control CPU 8c provided in the camera controller (AT) 8.

Operating the power switch connected to the main power supply (PS) 16 of the camcorder activates the blocks like the camera controller (AT) 8, and thus, the modes is shifted from the power off (OFF) state to the standby mode (STBY). Then, operating a recording button shifts the mode to the recording mode (REC), or operating a playback button shifts the mode to the playback mode (PB). When a predetermined period of time (for example, about one minute) has elapsed without any operation, the mode is shifted to the standby off mode (STBYOFF). After the camcorder becomes the standby off mode (STBYOFF), to select the standby mode (STBY) again, for example, a stop button is operated.

Then, when a predetermined period of time (for example, about five minutes) has elapsed without any operation in the standby off mode (STBYOFF), the mode is automatically shifted to the VTR off mode (SAVE1) with the further reduced power consumption. In this mode, a monitor image (camera EE image) can be displayed, and various settings such as adjustment for image quality using the camera can be performed.

Then, when a predetermined period of time (for example, about one hour) has elapsed without any operation in the VTR off mode (SAVE1), the mode is automatically shifted to the shutdown mode (SAVE2) with the minimum power consumption. The period of time for the transition of modes can be set appropriately by a user of the camcorder. Also, the user may inhibit the mode from being shifted to the shutdown mode (SAVE2).

Also, when the camcorder is in the VTR off mode (SAVE1), or in the shutdown mode (SAVE2), the user may select the recording mode or the playback mode by operating the recording button or the playback button, after the mode is once shifted to the standby mode (STBY). It is noted that the shutdown mode (SAVE2) allows access to keys provided at the inside panel 8a.

Since the mode can be shifted to the power off (OFF) condition from any operation mode by operating the power switch connected to the main power supply (PS) 16, the mode is usually shifted to the standby mode (STBY) once, termination processing in the camcorder is performed, and then the mode is shifted to the power off (OFF) condition.

As described above, the camcorder according to the embodiment employs a power supply control method which allows selection of the VTR off mode (SAVE1) for generating an image output (camera EE image) from the camera signal processing section and driving the CPU of the system control section that controls the recording/playback section in the sleep mode; and selection of the shutdown mode (SAVE2) for supplying power only to the camera control section that controls driving of the camera signal processing section. Accordingly, not only the power consumption can be reduced in the standby off mode (STBYOFF) of the related art, but also consumption of a battery can be reduced. Also, in any of the operation modes, since the DC/DC converters are stopped for the circuit blocks which are not used, and the power is no longer supplied thereto, the power consumption can be minimized. Accordingly, the camcorder can be used for a long time with a small battery power.

These newly added operation modes contribute to marked reduction in power consumption when shooting does not have to be started immediately, such as for making a TV program in a studio. In particular, the VTR off mode (SAVE1) can markedly reduce the power consumption under the condition that image recording is not performed for a long time while the output of the monitor image is continued.

The present invention can be applied not only to the recording/playback apparatus with the camera integrated, but also to an image recording/playback apparatus using a separately provided video camera unit. In this case, the system CPU 100 of the system/audio controller (SA) 10 may be driven in the sleep mode in the shutdown mode of the image recording/playback apparatus. Accordingly, the recording button or the playback button can be effectively recognized, so that the mode can be shifted to the standby mode.

It should be understood by those skilled in the art that various modifications, combinations, sub-combinations and alterations may occur depending on design requirements and other factors insofar as they are within the scope of the appended claims or the equivalents thereof.

What is claimed is:

1. An imaging device that captures an image using a solid-state image sensor, the device comprising:
a recording/playback section that records a captured image signal as a recording signal on a recording medium and reads the recorded signal as a playback signal;
a recording/playback control section that controls a recording operation and a playback operation performed in the recording/playback section;
a monitor image processing section that generates a display image signal for monitor displaying on the basis of the captured image signal;
a power supply section having a plurality of power supply circuits for supplying power independently to at least the recording/playback section, the recording/playback control section, and the monitor image processing section; and
a system control section that controls a condition of power supply from the power supply section by selecting one of a plurality of operation modes including a power save mode in which the power supply circuit for supplying power to the recording/playback section is stopped and the recording/playback control section is driven to perform minimum processing necessary for a recovery operation of the recording/playback section, while power is supplied from the power supply section to the monitor image processing section to generate the display image signal.

2. The imaging device according to claim 1, wherein the operation modes further include a recording standby mode in which the recording/playback control section is normally operated, and power is supplied to at least a circuit of the recording/playback section.

3. The imaging device according to claim 2, wherein the system control section shifts the recording standby mode to the power save mode if the system control section does not receive an operation instruction caused by an input operation for a predetermined period of time in the recording standby mode.

4. The imaging device according to claim 2, wherein the recording/playback section records and reads a signal through a rotation drum using a magnetic tape, and is controlled such that, in the recording standby mode, a servo control circuit for the rotation drum and the magnetic tape is driven in a sleep mode, and in the power save mode, no power is supplied to the entire recording/playback section including the servo control circuit.

5. The imaging device according to claim 2,
wherein the operation modes further include a quick recording standby mode in which power is supplied to circuits in the recording/playback section, the number of the power-supplied circuits being larger than that in the recording standby mode, and the recording operation is started immediately in response to a start instruction of the recording operation, and
wherein the system control section shifts the quick recording standby mode to the recording standby mode if the system control section does not receive an operation instruction caused by an input operation for a predetermined period of time in the quick recording standby mode.

6. The imaging device according to claim 5, wherein the recording/playback section records and reads a signal through a rotation drum using a magnetic tape, and is controlled such that, in the quick recording standby mode, the rotation drum is rotated to prepare for the recording operation, and in the recording standby mode and the power save mode, the rotation of the rotation drum is stopped.

7. The imaging device according to claim 5, wherein the system control section shifts the power save mode to the quick recording standby mode, and then allows the recording/playback section to start the recording operation if the system control section receives a start instruction of the recording operation in the power save mode.

8. The imaging device according to claim 1,
wherein the operation modes further include a non-display power save mode in which power is not supplied to the monitor image processing section, and only the system control section is operated, and
wherein the system control section shifts the power save mode to the non-display power save mode if the system control section does not receive an operation instruction caused by an input operation for a predetermined period of time in the power save mode.

9. The imaging device according to claim 1, wherein the power supply circuit employs a direct voltage converter circuit.

10. An image recording/playback apparatus to which an imaging device is connectable, the apparatus comprising:
a recording/playback section that records a captured image signal from the imaging device as a recording signal on a recording medium, and reads the recorded signal as a playback signal;
a recording/playback control section that controls a recording operation and a playback operation performed in the recording/playback section;
a power supply section having a plurality of power supply circuits for supplying power independently to at least the recording/playback section, and the recording/playback control section; and
a system control section that controls a condition of power supply from the power supply section by selecting one of a plurality of operation modes including a power save mode in which the power supply circuit for supplying power to the recording/playback section is stopped and the recording/playback control section is driven to perform minimum processing necessary for a recovery operation of the recording/playback section, while the imaging device continuously performs an imaging operation.

11. A power supply control method for an imaging device including a recording/playback section that records a captured image signal obtained by a solid-state image sensor as a recording signal on a recording medium and reads the recorded signal as a playback signal, and a monitor image processing section that generates a display image signal for monitor displaying on the basis of the captured image signal, the method being performed by a system control section, and comprising the step of:
selecting one of a plurality of operation modes including a power save mode in which a second power supply circuit for supplying power to the recording/playback section is stopped and the recording/playback control section that controls a recording operation and a playback operation performed in the recording/playback section is driven to perform minimum processing necessary for a recovery operation of the recording/playback section, while power is supplied from a first power supply circuit to the monitor image processing section to generate the display image signal, so as to control a condition of power supply in the imaging device.
